(19) United States
(12) Patent Application Publication
(10) Pub. No.: US 2023/0239026 A1
(43) Pub. Date: Jul. 27, 2023

(54) FAST OUTERLOOP LINK ADAPTATION

(71) Applicant: Telefonaktiebolaget LM Ericsson (publ), Stockholm (SE)

(72) Inventors: Akram BIN SEDIQ, Kanata (CA); Aaron CALLARD, Ottawa (CA); Christian SKÄRBY, Stockholm (SE)

(21) Appl. No.: 18/001,629

(22) PCT Filed: Jun. 16, 2020
(86) PCT No.: PCT/IB2020/055624

§ 371 Date: Dec. 13, 2022

(51) Int. Cl. H04B 7/06

(52) U.S. Cl. CPC H04B 7/0626; H04B 7/0632

(57) ABSTRACT

According to one or more embodiments, a network node configured to communicate with a wireless device is provided. The network node includes processing circuitry configured to: receive a channel state information, CSI, report indicating a bias of the CSI report; determine the bias of the CSI report based at least on the indication; and set an initial outerloop link adaptation, OLLA, based at least on the determined bias of the CSI report.

### TECHNICAL FIELD

The present disclosure relates to wireless communications, and in particular, to outerloop link adaptation (OLLA) and modification of OLLA to be wireless device specific.

### BACKGROUND

### New Radio (NR) Also Referred to as 5^{th} Generation (5G)

The next generation mobile wireless communication systems promulgated by the 3rd Generation Partnership Project (3GPP) such as 5G or new radio NR, may support a diverse set of use cases and a diverse set of deployment scenarios. The later includes deployment at both low frequencies (100s of MHz), similar to 3GPP Long Term Evolution (LTE, also referred to as 4^{th} Generation (4G)), and very high frequencies (mm waves in the tens of GHz).

Similar to LTE, NR may use OFDM (Orthogonal Frequency Division Multiplexing) in the downlink (i.e., from a network node (e.g., gNB, eNB, or base station) to a wireless device (e.g., user equipment or UE)). The basic NR physical resource over an antenna port can thus be seen as a time-frequency grid as illustrated in FIG. 1, where a resource block (RB) in a 14-symbol slot is illustrated. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf = (15 × 2^{α}) kHz where α ∈ (0,1,2,3,4). Δf = 15 kHz is the basic (or reference) subcarrier spacing that is also used in LTE.

In the time domain, downlink and uplink transmissions in NR may be organized into equally-sized subframes of 1 ms each similar to LTE. A subframe is further divided into multiple slots of equal duration. The slot length for subcarrier spacing Δf = (15 × 2^{α}) kHz is ½^{α} ms. There is only one slot per subframe at Δf = 15 kHz and a slot consists of 14 OFDM symbols.

Downlink transmissions are dynamically scheduled, i.e., in each slot the network node transmits downlink control information (DCI) about which wireless device data is to be transmitted to and which resource blocks in the current downlink slot the data is transmitted on. This control information is typically transmitted in the first one or two OFDM symbols in each slot in NR. The control information is carried on the Physical Control Channel (PDCCH) and data is carried on the Physical Downlink Shared Channel (PDSCH). A wireless device first detects and decodes PDCCH and if a PDCCH is decoded successfully, it then decodes the corresponding PDSCH based on the decoded control information in the PDCCH. An example is shown in FIG. 2, where the PDCCH is transmitted in the first two symbols and PDSCH is transmitted in the rest of the symbols in a slot.

In addition to PDCCH and PDSCH, there are also other channels and reference signals transmitted in the downlink. One of the reference signals is the Channel-State Information Reference Signal (CSI-RS).

A channel-state information reference signal (CSI-RS) resource includes one or more downlink time-frequency resource elements (REs) with radio resource control (RRC)-configurable attributes, to be used by the wireless device to perform measurements. According to one or more wireless communication standards such as 3GPP Release 15, three types of CSI-RS resources are defined:
Non-Zero-Power CSI-RS (NZP-CSI-RS): These resources are transmitted by the network node carrying predetermined reference signals that can be used by the wireless device to estimate the channel. NZP CSI-RS can also be used for interference measurement, typically, intra-cell interference, such as interference due to co-scheduled MU-MIMO wireless devices.
Zero-Power CSI-RS (ZP-CSI-RS): These resources are used for rate matching, i.e., the wireless device may assume that the REs occupied by ZP-CSI-RS are not used for Physical Downlink Shared Channel (PDSCH) transmission.
CSI-Interference Measurement (CSI-IM): These resources are used for interference measurement, typically, inter-cell interference.

To illustrate the use of the above three types of resource, the case of obtaining channel-quality-indicator (CQI) is considered. For the wireless device to estimate CQI, the wireless device may need to estimate the channel strength as well as the interference plus noise. One way to facilitate such estimations is by configuring the wireless device with the following:
NZP CSI-RS to estimate the channel;
CSI-IM to estimate the interference, where the serving network node does not transmit any signal in these CSI-IM resources so the wireless device can measure inter-cell interference plus noise in these resources; and
One or more ZP-CSI-RS resource for the same REs that constitute CSI-IM, in order to inform the wireless device that no PDSCH transmission is occurring in these REs.

### Downlink Link Adaption Background

To help deliver the best downlink (DL) throughput to the wireless device, the network node may need to adapt its transmission parameters to the wireless device’s channel condition. For instance, a wireless device experiencing favorable channel conditions, i.e., the wireless device has a high signal to interference and noise ratio (SINR), may be communicated with using more spectral-efficient modulation and coding scheme (MCS), and vice versa. If a more aggressive MCS is chosen than what the channel can support, there is a high chance the transmission is not decoded successfully at the wireless device, and the wireless device then reports a negative acknowledgment (NACK) using Hybrid Automatic Request Control (HARQ) mechanism.

In order for the network node to adapt the transmission parameters, the network node should have good knowledge of the wireless device’s channel conditions. One manner for the network node to get the wireless device’s channel condition is through CSI measurement reporting where the wireless device measures the CSI based on NZP CSI-RS, CSI-IM reference signals and reports the CSI to the network node. CSI can then be used to estimate the SINR at the wireless device side.

One of the problems with CSI measurement is that the CSI measurement can be biased by wireless device-specific implementations. That is, two different wireless devices experiencing the same SINR may report different CSI due to different biases in the implementations which are not known at the network node. Another problem with CSI measurement is that it is measured on reference signals that may not necessarily experience the same SINR as the resources used for actual data transmission in PDSCH.

One solution to help address the above mentioned problems is to use an outerloop link adaptation (OLLA), which is a control loop that continuously corrects the SINR estimate based on Hybrid Automatic Repeat Request (HARQ) acknowledgement/negative acknowledgement (ACK/NACK) feedbacks. For instance, an outerloop can be implemented as follows:

$$\begin{matrix}S I N {R}_{e s t} = S I N {R}_{r e p o r t e d} + O L L A , \\ O L L A : = O L L A + \left\{\begin{matrix}S t e {p}_{u p} & I f A C K \\ - S t e {p}_{u p} \times \frac{1 - B L E {R}_{t a r g e t}}{B L E {R}_{t a r g e t}} & I f N A C K\end{matrix}\right)\end{matrix}$$

Where
SINRₑₛₜ is the estimated SINR in dB scale that includes a correction term, and it can be used for link adaption;
SINR_{reported} is the SINR in dB scale derived from CSI report without any correction. This reported SINR can include a bias that shifts it from the true value due to imperfect wireless device implementation;
OLLA is the outerloop correction term update upon reception of HARQ feedbacks (ACK/NACK);
Stepᵤₚ is a configured parameter specifying the amount of increase (dB) in OLLA if an ACK is received;
BLER_{target} is a configured target block error rate (BLER); a common value for this parameter is 0.1 (i.e., 10% block error rate for PDSCH transmission);

However, for OLLA, there is no suitable method for specifying the initial value for OLLA where the initial value for OLLA affects the converge speed depending on the bias of the estimated SINR. For example, the convergence of OLLA can be slow when the initial bias is set too large or too small compared to the actual bias, which negatively results in reduced communication throughput. The actual initial bias can be due to various reasons such as imperfect implementation at the wireless device.

### SUMMARY

Some embodiments advantageously provide methods, systems, wireless device and network node for outerloop link adaptation (OLLA) and modification of OLLA to be wireless device specific.

In one or more embodiments, the initial value of OLLA is modified to be wireless device specific and based on a new CSI report to compensate for imperfect implementation at the wireless device. In particular, in one or more embodiments, the wireless device is configured to report additional CSI measurement with the purpose of estimating the CSI report bias and not the actual CSI. This additional CSI measurement is configured such that the reported CSI is aprioi known at the network node if the there is no bias, and thus the difference between the reported CSI and the aprioir known value can be used by the network node to derive the bias.

In one or more embodiments, the additional CSI measurement is configured so the wireless device measures the channel component and interference component from the same source so that the reported CSI may correspond to 0 dB if no bias exists. The reported CSI can then be readily used to derive the bias which is used to set the initial value of OLLA.

In another embodiment, the additional CSI measurement is configured so the wireless device measures the channel component and interference component from the same source but the channel component is “wrongly” configured to be X dB more than the actual value, so that the reported CSI may correspond to X dB if no bias exists. The reported CSI can then be readily used to derive the bias which is used to set the initial value of OLLA. In one or more embodiments, “wrongly” configured may corresponds to setting an offset value when no offset value would ordinarily not be needed in order to be able to derive the bias.

In one or more embodiments, the additional CSI measurement is configured so the wireless device measures the channel component and interference component on the same resource elements to save on signaling overhead, i.e., to reduce an amount of resources used compared to other methods.

According to one aspect of the disclosure, a network node configured to communicate with a wireless device is provided. The network node includes processing circuitry configured to: receive a channel state information, CSI, report indicating a bias of the CSI report; determine the bias of the CSI report based at least on the indication; and set an initial outerloop link adaptation, OLLA, based at least on the determined bias of the CSI report.

According to one or more embodiments of this aspect, the indicated bias of the CSI report is indicated by a channel quality indicator, CQI, value included in the CSI report. According to one or more embodiments of this aspect, the CQI value is based on a mapping of at least one channel quality measurement to one of a plurality of CQI values. According to one or more embodiments of this aspect, the channel quality measurement is based at least on: a measurement of a channel component and a measurement of an interference component that are performed on a same signal source; and a bias value in the channel quality measurement, the bias value in the channel quality measurement corresponding to the bias in the CSI report.

According to one or more embodiments of this aspect, the indication is configured to indicate a predefined dB value for a CSI report having no bias. According to one or more embodiments of this aspect, the predefined dB value is one of a zero dB value and a non-zero dB value. According to one or more embodiments of this aspect, the non-zero dB value is an offset set value of the channel component. According to one or more embodiments of this aspect, the CQI value is an average CQI value based on a reference signal sweep over a plurality of resources. According to one or more embodiments of this aspect, the processing circuitry is further configured to transmit a request for the CSI report with the indication of the bias of the CSI report.

According to another aspect of the disclosure, a wireless device configured to communicate with a network node is provided. The wireless device includes processing circuitry configured to: perform at least one channel quality measurement; and transmit a channel state information, CSI, report indicating a bias of the CSI report where the bias of the CSI report is based at least on the at least one channel quality measurement and is configured to allow for setting of an initial outerloop link adaptation, OLLA.

According to one or more embodiments of this aspect, the indicated bias of the CSI report is indicated by a channel quality indicator, CQI, value included in the CSI report. According to one or more embodiments of this aspect, the processing circuitry is further configured to map at least one channel quality measurement to one of a plurality of CQI values, the CQI value indicated in the CSI report being based on the mapping. According to one or more embodiments of this aspect, the processing circuitry is further configured to: receive a reference signal that is swept over a plurality of resources; perform a plurality of channel quality measurement for the plurality of resources based on the reference signal sweep; determine a plurality of CQI values based on the plurality of channel quality measurements; and the CQI value is an average CQI value based on the plurality of CQI values.

According to one or more embodiments of this aspect, the channel quality measurement is based at least on: a measurement of a channel component and a measurement of an interference component that are performed on a same signal source; and a bias value in the channel quality measurement, the bias value in the channel quality measurement corresponding to the bias in the CSI report. According to one or more embodiments of this aspect, the indication is configured to indicate a predefined dB value for a CSI report having no bias. According to one or more embodiments of this aspect, the predefined dB value is one of a zero dB value and a non-zero dB value. According to one or more embodiments of this aspect, the non-zero dB value is an offset set value of the channel component. According to one or more embodiments of this aspect, the processing circuitry is further configured to receive a request for the CSI report with the indication of the bias of the CSI report.

According to another aspect of the disclosure, a method implemented by a network node that is configured to communicate with a wireless device is provided. A channel state information, CSI, report indicating a bias of the CSI report; is received. The bias of the CSI report is determined based at least on the indication. An initial outerloop link adaptation, OLLA, is set based at least on the determined bias of the CSI report.

According to one or more embodiments of this aspect, the indicated bias of the CSI report is indicated by a channel quality indicator, CQI, value included in the CSI report. According to one or more embodiments of this aspect, the CQI value is based on a mapping of at least one channel quality measurement to one of a plurality of CQI values. According to one or more embodiments of this aspect, the channel quality measurement is based at least on: a measurement of a channel component and a measurement of an interference component that are performed on a same signal source; and a bias value in the channel quality measurement, the bias value in the channel quality measurement corresponding to the bias in the CSI report.

According to one or more embodiments of this aspect, the indication is configured to indicate a predefined dB value for a CSI report having no bias. According to one or more embodiments of this aspect, the predefined dB value is one of a zero dB value and a non-zero dB value. According to one or more embodiments of this aspect, the non-zero dB value is an offset set value of the channel component. According to one or more embodiments of this aspect, the CQI value is an average CQI value based on a reference signal sweep over a plurality of resources. According to one or more embodiments of this aspect, a request is transmitted for the CSI report with the indication of the bias of the CSI report.

According to another aspect of the disclosure, a method implemented by a wireless device that is configured to communicate with a network node is provided. At least one channel quality measurement is performed. A channel state information, CSI, report indicating a bias of the CSI report is transmitted where the bias of the CSI report is based at least on the at least one channel quality measurement and is configured to allow for setting of an initial outerloop link adaptation, OLLA.

According to one or more embodiments of this aspect, the indicated bias of the CSI report is indicated by a channel quality indicator, CQI, value included in the CSI report. According to one or more embodiments of this aspect, mapping at least one channel quality measurement is mapped to one of a plurality of CQI values, the CQI value indicated in the CSI report being based on the mapping. According to one or more embodiments of this aspect, a reference signal that is swept over a plurality of resources is received. A plurality of channel quality measurement are performed for the plurality of resources based on the reference signal sweep. A plurality of CQI values are determined based on the plurality of channel quality measurements. The CQI value is an average CQI value based on the plurality of CQI values.

According to one or more embodiments of this aspect, the channel quality measurement is based at least on: a measurement of a channel component and a measurement of an interference component that are performed on a same signal source; and a bias value in the channel quality measurement, the bias value in the channel quality measurement corresponding to the bias in the CSI report. According to one or more embodiments of this aspect, the indication is configured to indicate a predefined dB value for a CSI report having no bias. According to one or more embodiments of this aspect, the predefined dB value is one of a zero dB value and a non-zero dB value.

According to one or more embodiments of this aspect, the non-zero dB value is an offset set value of the channel component. According to one or more embodiments of this aspect, a request for the CSI report with the indication of the bias of the CSI report is received.

By obtaining the bias in CSI reports, the OLLA can converge much faster compared to existing methods, and thus higher throughput can be achieved by the teachings provided herein. This is especially true for wireless devices with imperfect implementation where the teachings use smaller payloads that may require a smaller number of transmissions.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram if a NR physical resource grid;

FIG. 2 is a diagram of a NR time-domain structure with 15 kHz subcarrier spacing;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating exemplary methods implemented in a communication system including a host computer, a network node and a wireless device for executing a client application at a wireless device according to some embodiments of the present disclosure;

FIG. 6 is a flowchart illustrating exemplary methods implemented in a communication system including a host computer, a network node and a wireless device for receiving user data at a wireless device according to some embodiments of the present disclosure;

FIG. 7 is a flowchart illustrating exemplary methods implemented in a communication system including a host computer, a network node and a wireless device for receiving user data from the wireless device at a host computer according to some embodiments of the present disclosure;

FIG. 8 is a flowchart illustrating exemplary methods implemented in a communication system including a host computer, a network node and a wireless device for receiving user data at a host computer according to some embodiments of the present disclosure;

FIG. 9 is a flowchart of an exemplary process in a network node according to some embodiments of the present disclosure; and

FIG. 10 is a flowchart of an exemplary process in a wireless device according to some embodiments of the present disclosure.

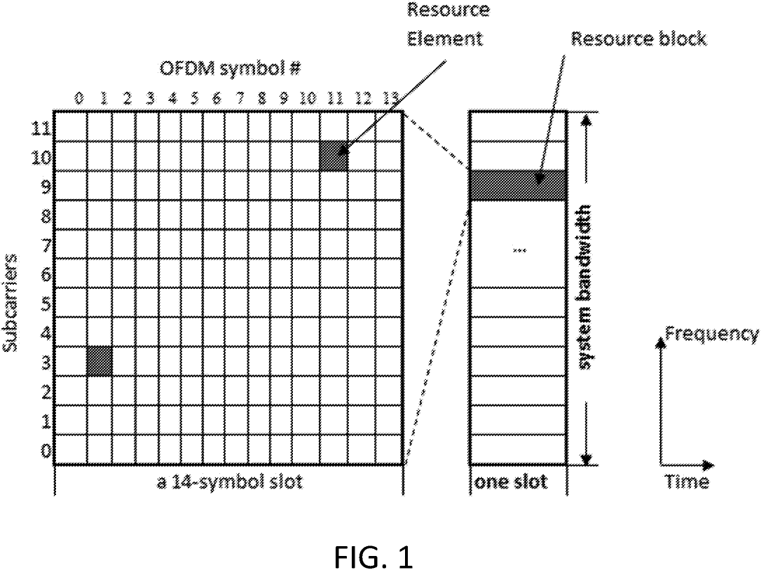

### DETAILED DESCRIPTION

Before describing in detail exemplary embodiments, it is noted that the embodiments reside primarily in combinations of apparatus components and processing steps related to outerloop link adaptation (OLLA) and modification of OLLA to be wireless device specific.

Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections. In some embodiments, the term “signal source” is used. As used herein, “signal source” refers to a radio resource.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information. For example, an indication may indicate a bias such as a CSI report bias.

A cell may be generally a communication cell, e.g., of a cellular or mobile communication network, provided by a node. A serving cell may be a cell on or via which a network node (the node providing or associated to the cell, e.g., base station, gNB or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

Configuring a terminal or wireless device or node may involve instructing and/or causing the wireless device or node to change its configuration and/or to operating according to a configuration and/or parameter, e.g., at least one setting and/or register entry and/or operational mode. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which modulation and/or encoding to use. A terminal may be configured with and/or for scheduling data and/or to use, e.g., for transmission, scheduled and/or allocated uplink resources, and/or, e.g., for reception, scheduled and/or allocated downlink resources, and/or for providing a bias. Uplink resources and/or downlink resources may be scheduled and/or provided with allocation or configuration data.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide outerloop link adaptation (OLLA) and modification of OLLA to be wireless device specific.

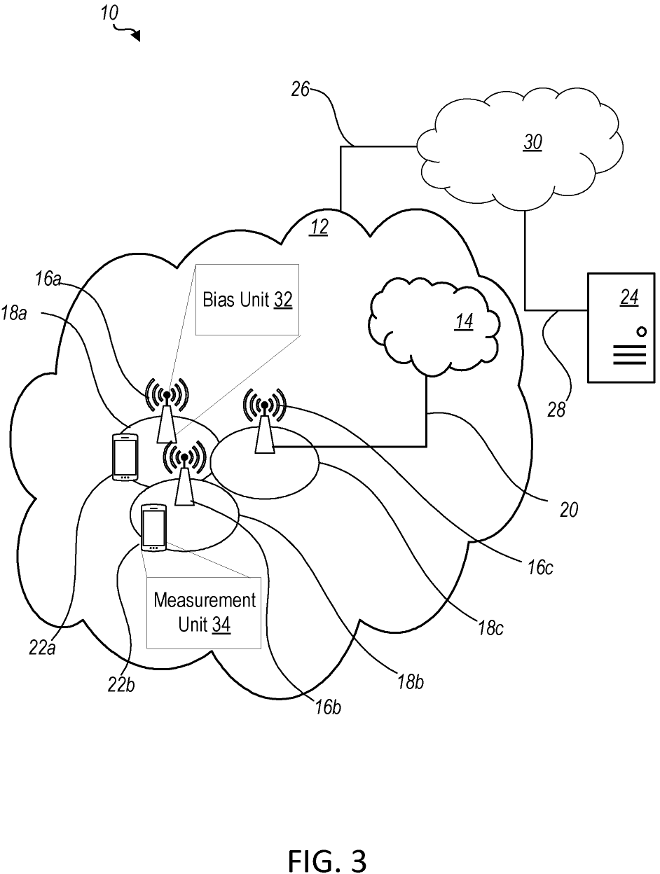

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a bias unit 32 which is configured to perform one or more network node 16 functions as described herein such as with respect to OLLA and modification of OLLA to be wireless device specific. A wireless device 22 is configured to include a measurement unit 34 which is configured to perform one or more wireless device 22 functions as described herein such as with respect to OLLA and modification of OLLA to be wireless device specific.

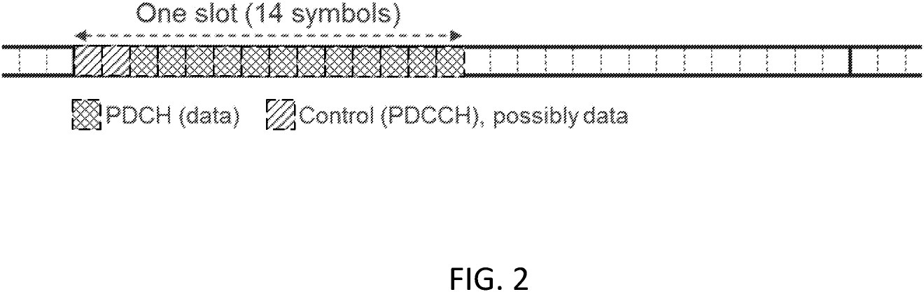

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more determine, process, store, transmit, receive, relay, forward, signal, configure, calculate, etc., information related to OLLA and modification of OLLA to be wireless device specific.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include bias unit 32 configured to perform one or more network node 16 functions as described herein such as with respect to OLLA and modification of OLLA to be wireless device specific.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 configured to perform one or more network node 16 functions as described herein such as with respect to OLLA and modification of OLLA to be wireless device specific.

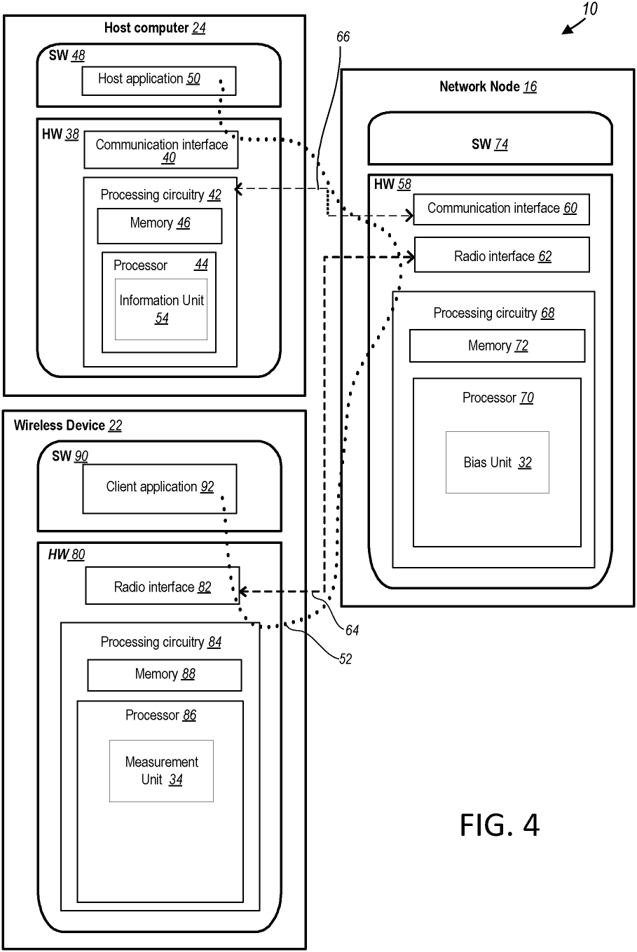

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer’s 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node’s 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as bias unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

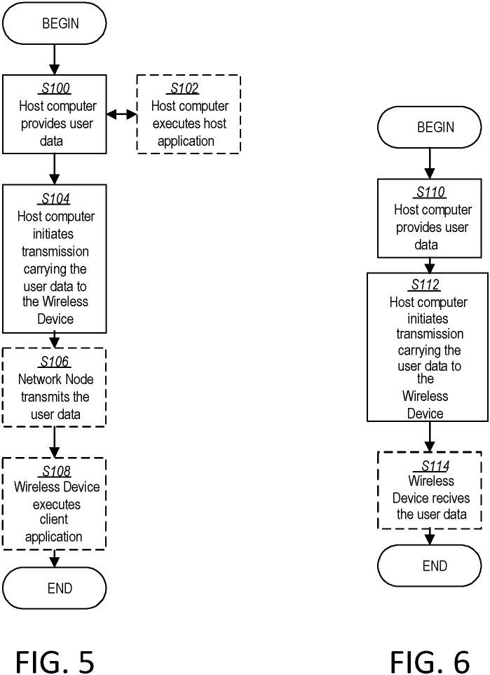

FIG. 5 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

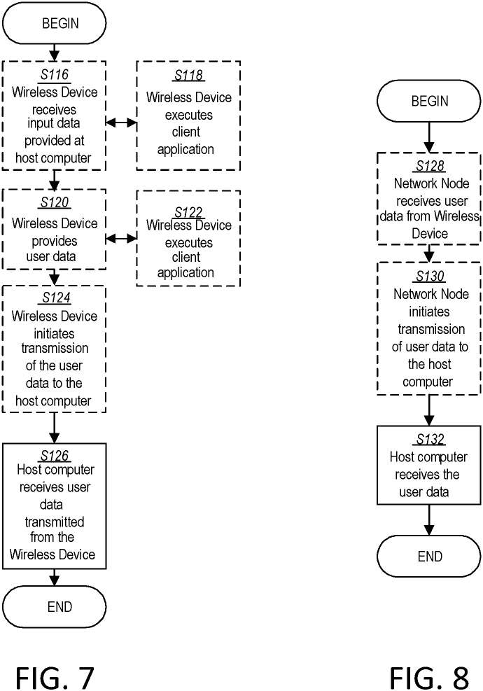

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

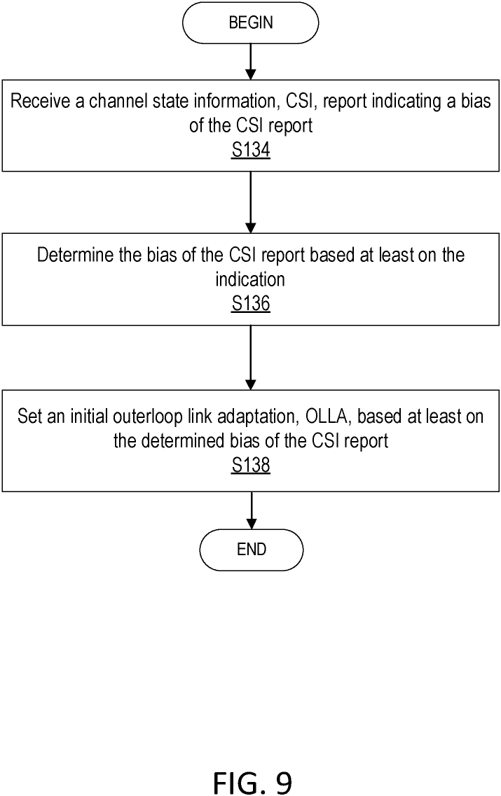

FIG. 9 is a flowchart of an exemplary process in a network node according to some embodiments of the present disclosure. One or more Blocks and/or functions performed by network node 16 may be performed by one or more elements of network node 16 such as by bias unit 32 in processing circuitry 68, processor 70, radio interface 62, etc. In one or more embodiments, network node 16 such as via one or more of processing circuitry 68, processor 70, bias unit 32, communication interface 60 and radio interface 62 is configured to receive (Block S134) a channel state information, CSI, report indicating a bias of the CSI report, as described herein. In one or more embodiments, network node 16 such as via one or more of processing circuitry 68, processor 70, bias unit 32, communication interface 60 and radio interface 62 is configured to determine (Block S136) the bias of the CSI report based at least on the indication, as described herein. In one or more embodiments, network node 16 such as via one or more of processing circuitry 68, processor 70, bias unit 32, communication interface 60 and radio interface 62 is configured to set (Block S138) an initial outerloop link adaptation, OLLA, based at least on the determined bias of the CSI report, as described herein.

According to one or more embodiments, the indicated bias of the CSI report is indicated by a channel quality indicator, CQI, value included in the CSI report. According to one or more embodiments, the CQI value is based on a mapping of at least one channel quality measurement to one of a plurality of CQI values. According to one or more embodiments, the channel quality measurement is based at least on: a measurement of a channel component and a measurement of an interference component that are performed on a same signal source; and a bias value in the channel quality measurement, the bias value in the channel quality measurement corresponding to the bias in the CSI report.

According to one or more embodiments, the indication is configured to indicate a predefined dB value for a CSI report having no bias. According to one or more embodiments, the predefined dB value is one of a zero dB value and a non-zero dB value. According to one or more embodiments, the non-zero dB value is an offset set value of the channel component. According to one or more embodiments, the CQI value is an average CQI value based on a reference signal sweep over a plurality of resources. According to one or more embodiments, the processing circuitry is further configured to transmit a request for the CSI report with the indication of the bias of the CSI report.

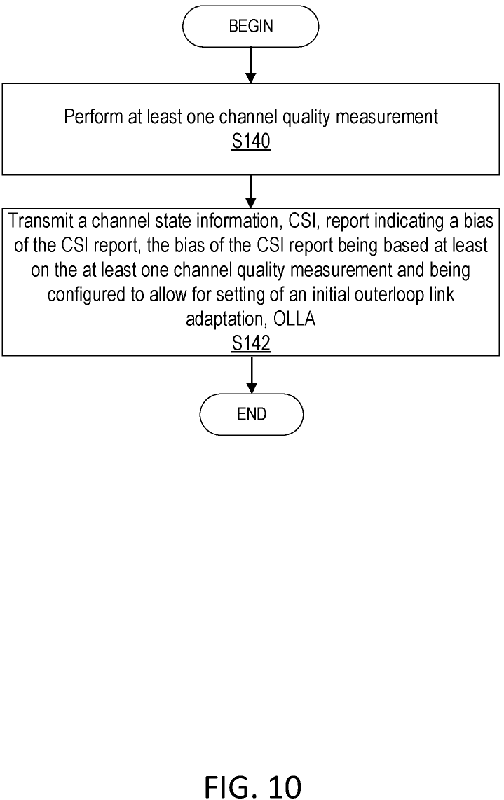

FIG. 10 is a flowchart of an exemplary process in a wireless device according to some embodiments of the present disclosure. One or more Blocks and/or functions performed by wireless device 22 may be performed by one or more elements of wireless device 22 such as by measurement unit 34 in processing circuitry 84, processor 86, radio interface 82, etc. In one or more embodiments, wireless device such as via one or more of processing circuitry 84, processor 86, measurement unit 34 and radio interface 82 is configured to perform (Block S140) at least one channel quality measurement, as described herein. In one or more embodiments, wireless device such as via one or more of processing circuitry 84, processor 86, measurement unit 34 and radio interface 82 is configured to transmit (Block S142) a channel state information, CSI, report indicating a bias of the CSI report where the bias of the CSI report is based at least on the at least one channel quality measurement and is configured to allow for setting of an initial outerloop link adaptation, OLLA.

According to one or more embodiments, the indicated bias of the CSI report is indicated by a channel quality indicator, CQI, value included in the CSI report. According to one or more embodiments, the processing circuitry is further configured to map at least one channel quality measurement to one of a plurality of CQI values, the CQI value indicated in the CSI report being based on the mapping. According to one or more embodiments, the processing circuitry is further configured to: receive a reference signal that is swept over a plurality of resources; perform a plurality of channel quality measurement for the plurality of resources based on the reference signal sweep; determine a plurality of CQI values based on the plurality of channel quality measurements; and the CQI value is an average CQI value based on the plurality of CQI values.

According to one or more embodiments, the channel quality measurement is based at least on: a measurement of a channel component and a measurement of an interference component that are performed on a same signal source; and a bias value in the channel quality measurement, the bias value in the channel quality measurement corresponding to the bias in the CSI report. According to one or more embodiments, the indication is configured to indicate a predefined dB value for a CSI report having no bias. According to one or more embodiments, the predefined dB value is one of a zero dB value and a non-zero dB value. According to one or more embodiments, the non-zero dB value is an offset set value of the channel component. According to one or more embodiments, the processing circuitry is further configured to receive a request for the CSI report with the indication of the bias of the CSI report.

One or more embodiments described herein may be transparent to wireless device 22 such that wireless device 22 is unaware that it is reporting a bias associated with the wireless device 22.

Having generally described arrangements for OLLA and modification of OLLA to be wireless device specific, details for these arrangements, functions and processes are provided as follows, and which may be implemented by the network node 16, wireless device 22 and/or host computer 24.

Some embodiments provide OLLA and modification of OLLA to be wireless device specific.

According to one or more embodiments, the initial value of OLLA is modified to be wireless device specific and based on a new CSI report to compensate for a wireless device’s imperfect implementation. In particular, in one or more embodiments, the wireless device 22 such as via one or more of processing circuitry 84, processor 86, radio interface 82, measurement unit 34, etc., is configured to report additional and/or a different CSI measurement with the purpose of estimating the CSI report bias and not the actual CSI. This additional CSI measurement is configured such that the reported CSI is aprioi known at the network node 16 if the there is no bias, and thus the difference between the reported CSI and the aprioir known value can be used to derive the bias. For instance, in NR, CSI includes the channel quality indicator (CQI) which is derived from signal-to-interference-and-noise-ratio (SINR). SINR, is calculated in dB scale as

$$10 l o {g}_{10} \frac{R e c e i v e d s i g n a l p o w e r}{I n t e r f e r e n c e P o w e r + N o i s e P o w e r}$$

Due to imperfection at the wireless device’s implementation, the SINR measured at the wireless device may be actually equal to

$$10 l o {g}_{10} \left(\frac{R e c e i v e d s i g n a l p o w e r}{I n t e r f e r e n c e P o w e r + N o i s e P o w e r}\right) + b i a s ,$$

where the bias can be time-varying and wireless device dependent. Imperfection, as used herein may, for example, be at the wireless device in hardware or in software. Imperfection in software may be, for example, to reduce computational complexity at the expense of CQI estimation accuracy. Imperfection in the hardware may be, for example, to reduce the cost of the device components involved in estimating the CQI, such as antennas, power amplifiers, etc. One aspect of the disclosure is to obtain this bias faster and use it to initialize OLLA.

In one or more embodiments, the additional CSI measurement is configured so the wireless device 22 such as via one or more of processing circuitry 84, processor 86, radio interface 82, measurement unit 34, etc., measures the channel (NZP CSI-RS) and interference component (CS-IM) from the same source (e.g., same resources, same communication beam, etc.,) so that ideally the reported CSI should correspond to 0 dB if no bias exists. The reported CSI can then be readily used to derive the bias which is used to set the initial value of OLLA. In particular, if Received signal power = Interference Power » Noise Power (which can be satisfied for interference limited wireless devices), then the estimated SINR at the wireless device 22 may be equal to (0 dB + bias). Thus, the CQI reported by the wireless device 22 such as via one or more of processing circuitry 84, processor 86, radio interface 82, measurement unit 34, etc., may reflect the bias which can be used by the network node 16 such as via one or more of processing circuitry 68, processor 70, radio interface 62, bias unit 32, etc., to initialize OLLA. For noise-limited wireless devices 22, the bias estimation can include an error component as the assumption that the expected SINR is 0 dB does not hold.

In one or more embodiments, the additional CSI measurement is configured so the wireless device 22 such as via one or more of processing circuitry 84, processor 86, radio interface 82, measurement unit 34, etc., measures the channel and interference component from the same source but the channel component is “wrongly” configured to be X dB more than the actual value, so that ideally the reported CSI may correspond to -X dB if no bias exists. “Wrongly” as used herein corresponds to an unneeded configuration for general operation, i.e., the X dB is not needed for general wireless device 22 operation but is advantageously used as described herein. In this case, the wireless device may report a CQI to the network node that corresponds to the following estimated SINR

$$10 l o {g}_{10} \left(\frac{R e c e i v e d s i g n a l p o w e r}{I n t e r f e r e n c e P o w e r + N o i s e P o w e r}\right) + b i a s - X$$

In one or more embodiments, the channel component that is “wrongly” configured is configured by the network node 16 such as via one or more of processing circuitry 68, processor 70, radio interface 62, bias unit 32, etc. The reported CSI can then be used to derive the bias which is used to set the initial value of OLLA. For instance, such configuration can be performed by the network node 16 such as via one or more of processing circuitry 68, processor 70, radio interface 62, bias unit 32, etc., by configuring the field powerControlOffset for the CSI-RS resource used for channel measurement by the wireless device 22 and/or by configuring one or more other fields that are able to provide and/or result in the X dB offset. In some embodiments, powerControlOffset may be an RRC parameter in NR that can be signaled using RRC signaling. Note that this embodiment may be considered a generalization of the previous embodiment, as the previous embodiment can be obtained by setting X= 0 dB. By using X to be greater than 0 dB this helps avoid truncation error as CQI is bounded between 0 and 15, i.e., X may be chosen to have expected SINR to map to CQI in the middle of the range between 0 and 15.

In one or more other embodiments, the additional CSI measurement is configured so the wireless device 22 such as via one or more of processing circuitry 84, processor 86, radio interface 82, measurement unit 34, etc., measures the channel and interference component on the same resource elements that would have been used to measure the regular CSI, thereby saving on signaling overhead or reduce signaling overhead compared to one or more other embodiments described herein.

One or more embodiments described above may be used only once when the wireless device 22 such as via one or more of processing circuitry 84, processor 86, radio interface 82, measurement unit 34, etc., connects to the network node 16 (e.g., radio resource control (RRC) connection) or with very high periodicity to occasionally correct OLLA. Alternatively, the procedure above may be executed with every regular CSI measurement that are used for link-adaptation in existing systems, compared to existing systems, the wireless device 22 may need to report two CSI measurements, the first CSI measurement is the regular measurement used in existing systems for link adaptation while the second CSI measurement is a bias measurement that is described herein.

In one or more other embodiments, the one or more procedures/methods described above may be triggered due to any event that can potentially change the bias at the wireless device 22. Such events include one or more of a change in wireless device 22 transmission mode, rank, precoding, and/or SINR, etc. The event at the wireless device 22 may be determined by network node 16 such as via one or more of processing circuitry 68, processor 70, radio interface 62, bias unit 32, etc., such that the process remains transparent to the wireless device 22.

In one or more embodiments, the network node 16 such as via one or more of processing circuitry 68, processor 70, radio interface 62, bias unit 32, etc., may request multiple bias measurements as described herein, and use the average of multiple biases to obtain a single bias. This averaging reduces the error in bias estimation.

In one or more embodiments, the network node 16 such as via one or more of processing circuitry 68, processor 70, radio interface 62, bias unit 32, etc., may sweep X in a range of values (e.g., {0,1,2, ..., 30 dB}), and for each X, the network node 16 such as via one or more of processing circuitry 68, processor 70, radio interface 62, bias unit 32, etc., requests CSI measurement as described herein such as in the “wrongly” configured embodiment to get the bias for each given X. For a given wireless device 22′s estimated SINR, the network node such as via one or more of processing circuitry 68, processor 70, radio interface 62, bias unit 32, etc., may find X that corresponds to the wireless device 22′s SINR (e.g., find X from the range of swept values that is closest to the wireless device 22′s SINR) and uses the corresponding bias for X when performing link-adaptation for the wireless device 22..

Therefore, in one or more embodiments described herein, one or more processes and/or methods are provided to estimate bias in the wireless device 22′s estimated SINR by special configuration of CSI-RS reports without wasting additional downlink CSI reference signals.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user’s computer, partly on the user’s computer, as a stand-alone software package, partly on the user’s computer and partly on a remote computer or entirely on the remote computer. In the latter scenario, the remote computer may be connected to the user’s computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, the network node comprising:
processing circuitry configured to:
receive a channel state information, CSI, report indicating a bias of the CSI report;
determine the bias of the CSI report based at least on the indication; and
set an initial outerloop link adaptation, OLLA, based at least on the determined bias of the CSI report.

2. The network node of claim 1, wherein the indicated bias of the CSI report is indicated by a channel quality indicator, CQI, value included in the CSI report.

3. The network node of claim 2, wherein the CQI value is based on a mapping of at least one channel quality measurement to one of a plurality of CQI values.

4. The network node of claim 3, wherein the channel quality measurement is based at least on:
a measurement of a channel component and a measurement of an interference component that are performed on a same signal source; and
a bias value in the channel quality measurement, the bias value in the channel quality measurement corresponding to the bias in the CSI report.

5. The network node of claim 4, wherein the indication is configured to indicate a predefined dB value for a CSI report having no bias.

6. The network node of claim 5, wherein the predefined dB value is one of a zero dB value and a non-zero dB value.

7. The network node of claim 6, wherein the non-zero dB value is an offset set value of the channel component.

8. The network node of claim 2, wherein the CQI value is an average CQI value based on a reference signal sweep over a plurality of resources.

9. The network node of claim 1, wherein the processing circuitry is further configured to transmit a request for the CSI report with the indication of the bias of the CSI report.

10. A wireless device configured to communicate with a network node, the wireless device comprising:
processing circuitry configured to:
perform at least one channel quality measurement; and
transmit a channel state information, CSI, report indicating a bias of the CSI report, the bias of the CSI report being based at least on the at least one channel quality measurement and being configured to allow for setting of an initial outerloop link adaptation, OLLA.

11. The wireless device of claim 10, wherein the indicated bias of the CSI report is indicated by a channel quality indicator, CQI, value included in the CSI report.

12. The wireless device of claim 11, wherein the processing circuitry is further configured to map at least one channel quality measurement to one of a plurality of CQI values, the CQI value indicated in the CSI report being based on the mapping.

13. The wireless device of claim 11, wherein the processing circuitry is further configured to:
receive a reference signal that is swept over a plurality of resources;
perform a plurality of channel quality measurement for the plurality of resources based on the reference signal sweep;
determine a plurality of CQI values based on the plurality of channel quality measurements; and
the CQI value is an average CQI value based on the plurality of CQI values.

14. The wireless device of claim 10, wherein the channel quality measurement is based at least on:
a measurement of a channel component and a measurement of an interference component that are performed on a same signal source; and
a bias value in the channel quality measurement, the bias value in the channel quality measurement corresponding to the bias in the CSI report.

15. The wireless device of claim 14, wherein the indication is configured to indicate a predefined dB value for a CSI report having no bias.

16. The wireless device of claim 15, wherein the predefined dB value is one of a zero dB value and a non-zero dB value.

17. The wireless device of claim 16, wherein the non-zero dB value is an offset set value of the channel component.

18. The wireless device of claim 10, wherein the processing circuitry is further configured to receive a request for the CSI report with the indication of the bias of the CSI report.

19. A method implemented by a network node that is configured to communicate with a wireless device, the method comprising:
receiving a channel state information, CSI, report indicating a bias of the CSI report;
determining the bias of the CSI report based at least on the indication; and
setting an initial outerloop link adaptation, OLLA, based at least on the determined bias of the CSI report.

20-27. (canceled)

28. A method implemented by a wireless device that is configured to communicate with a network node, the method comprising:
performing at least one channel quality measurement; and
transmitting a channel state information, CSI, report indicating a bias of the CSI report, the bias of the CSI report being based at least on the at least one channel quality measurement and being configured to allow for setting of an initial outerloop link adaptation, OLLA.

29-36. (canceled)
